(19) United States
(12) Patent Application Publication
(10) Pub. No.: US 2024/0140233 A1
(43) Pub. Date: May 2, 2024

(54) ELECTRIC VEHICLE CHARGING SYSTEM WITH CHARGING TRAY

(71) Applicant: EVJAM LLC, Minneapolis, MN (US)

(72) Inventors: Gregg KROMREY, Hudson, WI (US); Steven DICKE, Minneapolis, MN (US)

(73) Assignee: EVJAM LLC, Minneapolis, MN (US)

(21) Appl. No.: 18/385,189

(22) Filed: Oct. 30, 2023

Related U.S. Application Data
(60) Provisional application No. 63/420,475, filed on Oct. 28, 2022.

(51) Int. Cl. B60L 53/36; B60L 53/16; B60S 1/66

(52) U.S. Cl. CPC B60L 53/36; B60L 53/16; B60S 1/66; B60L 53/66

(57) ABSTRACT

One or more examples provide an electric vehicle charging system including a charging port having a charging tray having a charging receptacle disposed thereon, wherein the charging tray can be moved between a stored position, where the charging tray and charging receptacle are disposed within a body of the electric vehicle, and a charging position where the charging receptacle is exposed from the electric vehicle body to receive a charging plug of an external electric vehicle charging station.

### CROSS REFERENCE TO RELATED APPLICATION

This Non-Provisional Patent Application claims the benefit of the filing date of U.S. Provisional Patent Application Ser. No. 63/420,475, filed Oct. 28, 2022, which is herein incorporated by reference.

### TECHNICAL FIELD

The present disclosure relates generally to examples of electric vehicles and to devices for use with an electric vehicle, including electric vehicle batteries and electric vehicle charging devices.

### BACKGROUND

Electric vehicles (EVs), such as automobiles (e.g., cars and trucks), watercraft, all-terrain vehicles (ATVs), side-by-side vehicles (SSVs), and electric bikes, for example, offer a quiet, clean, and more environmentally friendly option to gas-powered vehicles. Electric vehicles have electric powertrains which typically include a rechargeable battery system, one or more electrical motors, each with a corresponding electronic power inverter (sometimes referred to as a motor controller), and various auxiliary systems (e.g., cooling systems). To enhance ownership and ensure availability, charging of EVs should be both timely and convenient.

For these and other reasons, there is a need for the present invention.

### SUMMARY

The present disclosure provides one or more examples of an electric vehicle and systems and/or devices for use with an electric vehicle.

Additional and/or alternative features and aspects of examples of the present technology will become apparent from the following description and the accompanying drawings.

### BRIEF DESCRIPTION OF THE DRAWINGS

The Figures generally illustrate one or more examples of an electric vehicle and/or devices for use with an electric vehicle such as electric vehicle batteries or electric vehicle charging systems.

FIG. 1A is a block and schematic diagram generally illustrating an electric vehicle having a charging system including a charging tray, according to examples of the present disclosure.

FIG. 1B is a block and schematic diagram generally illustrating an electric vehicle having a charging system including a charging tray, according to examples of the present disclosure.

FIG. 10 is a block and schematic diagram generally illustrating an electric vehicle having a charging system including a charging tray, according to examples of the present disclosure.

FIG. 2A is a block and schematic diagram generally illustrating an electric vehicle having a charging system including a charging tray, according to examples of the present disclosure.

FIG. 2B is a block and schematic diagram generally illustrating an electric vehicle having a charging system including a charging tray, according to examples of the present disclosure.

FIGS. 3A-3C are block and schematic diagrams generally illustrating an electric vehicle having a charging system including a charging tray, according to examples of the present disclosure.

FIG. 4 is a block and schematic diagram generally illustrating an electric vehicle having a charging system including a charging tray, according to examples of the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense. It is to be understood that features of the various examples described herein may be combined, in part or whole, with each other, unless specifically noted otherwise.

The following disclosure includes one or more examples of electric vehicles (EVs) with charging port devices and charging port devices and/or charging devices/systems for use with electric vehicles. One or more features of electric vehicle systems and devices are described in further detail in the following paragraphs and illustrated in the Figures. In particular, the present disclosure provides examples of an electric vehicle charging system having a charging tray.

EVs include a charging port for receiving a charging plug of an EV charging station to charge the onboard rechargeable battery. Such charging ports are typically disposed on a vertical, or non-horizontal surface of the EV and typically include a door that must be opened to insert the charging plug. The charging port doors can detract from the aesthetics of the vehicle, and the non-horizontal positioning may present difficulties for connecting to EV charging stations employing hands-free connection systems.

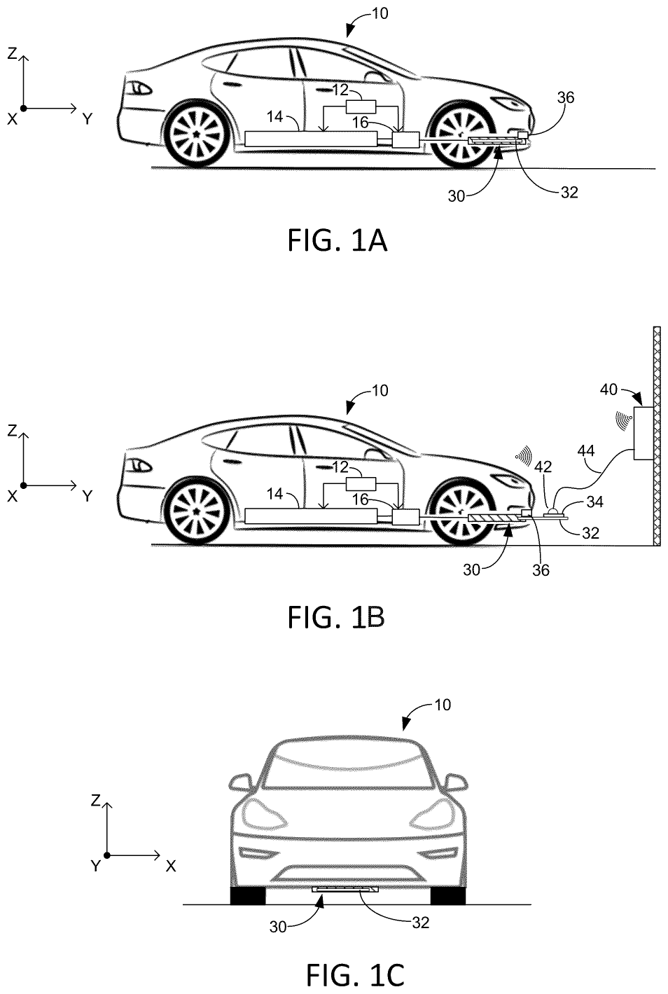

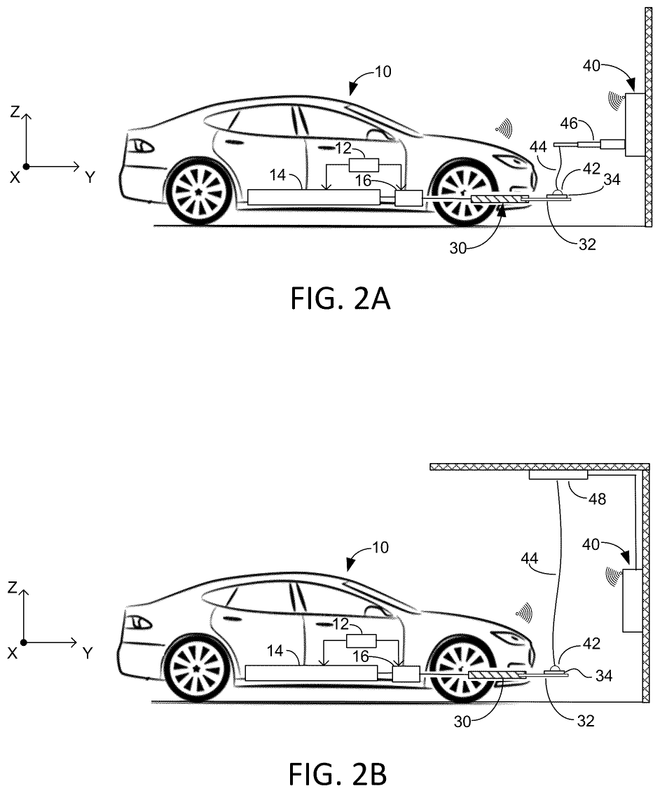

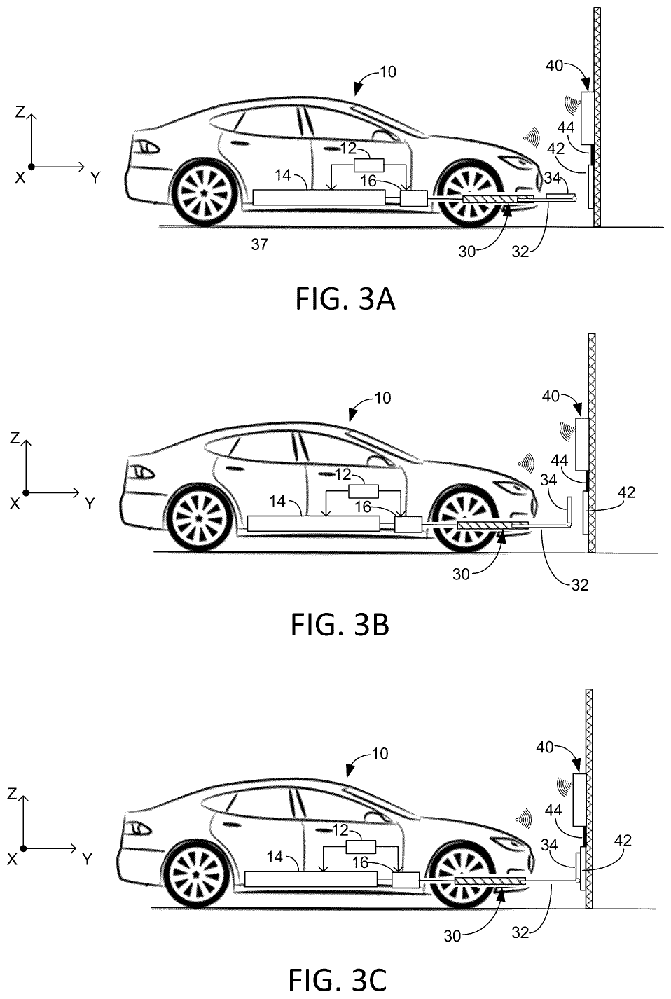

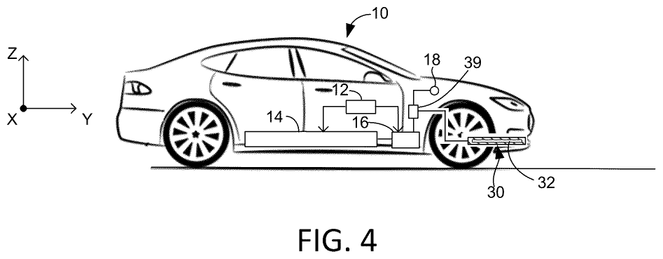

FIGS. 1A and 1B are block and schematic diagrams generally illustrating an EV 10 having a charging system including a charging port 30, according to examples of the present disclosure. In examples, EV 10 includes a vehicle control system 12, a rechargeable battery 14, and a battery charger 16, where charging port 30 is electrically connected to battery charger 16. In examples, charging port 30 includes a charging tray 32 and a charging receptacle 34 disposed thereon, wherein charging tray 32 is controllable to move back and forth between a retracted or stored position, as illustrated by FIG. 1A, and an extended or charging position to facilitate battery charging with an external EV charging station 40, as illustrated by FIG. 1B.

In examples, when in the stored position, charging tray 32 and charging receptacle 34 are stored in a sealed fashion within the body of EV 10 so as to be protected from dirt and debris when not being used for vehicle charging. In examples, during a battery charging operation, charging tray 32 is moved from the stored (retracted) position to the charging (extended) position. In one example, as charging tray 32 moves from the stored position to the charging position, a stationary cleaning element 36 (e.g., a brush) contacts receptacle 34 as it passes thereby to remove any dirt and debris that may have somehow accumulated on receptacle 34 prior to engaging a plug 42 of a charging cord 44 of external EV charging station 40.

In examples, a user of EV 10 initiates a charging operation (e.g., via a user interface on-board EV 10) which causes charging tray 32 to be moved from the stored position to the charging position. In some examples, EV 10 communicates with charging station 40, such as wirelessly (e.g., Bluetooth), and when charging station 40 determines that EV 10 is within a physical charging range (e.g., charging cord 44 will reach EV 10), signals EV 10 that it is within range for charging and to move charging tray 32 to the extended position.

With reference to FIG. 1B, as battery 14 is being charged, the plug 42 of power cord 44 of EV charging station 40 is received by and electrically connects to receptacle 34 which, in turn, is electrically connected to battery charger 16. Upon completion of the charging operation of battery 14, plug 42 is disconnected from receptacle 34, and charging tray 32 is returned to the stored position where, in some examples, cleaning element 36 again cleans and potential dirt and debris from receptacle 34.

In examples, when in the charging position, charging tray 32 provides receptacle 34 in a horizontal position. In examples, receptacle 34 may be configured to receive any type of male/female type connector plug, such as a J1772 plug, for instance. In other examples, receptacle 34 may be configured to provide a surface type connection to plug 42 of charging station 40. For example, in some cases, receptacle 34 may comprise stationary surface contacts against which corresponding surface contacts of plug 42 are biased (e.g., mechanically or magnetically biased contacts). In other cases, receptacle 30 includes surface contacts which are biased against corresponding stationary surface contacts of plug 42. In examples, receptacle 34 and plug 42 are configured with mechanical and/or magnetic alignment features to facilitate hands-free alignment there between. Such surface type connections between receptacle 32 of charging tray 32 and plug 42 of charging cord 44 may facilitate making hands-free connection between EV 10 and charging station 40 for the charging of battery 14.

FIGS. 2A and 2B are block and schematic diagrams generally illustrating examples of hands-free type connections with charging station 40. With reference to FIG. 2A, in one example, charging station 40 includes a controllable arm 46 (e.g., a telescoping arm) that can be controllably moved in the x- and y-directions by charging station 40 to align charging plug 42 with receptacle 34 of charging tray 32. In one example, charging station 40 wirelessly communicates (e.g., via Bluetooth) with EV 10 and indicates to EV 10 when it is within a physical charging range, at which point EV 10 enters a charging mode and extends charging tray 32 from the stored position to the charging position. Charging station 40 then moves controllable arm 46 to align plug 42 with receptacle 34. In examples, charging station 40 vertically lowers (i.e., z-direction) plug 42 which is then magnetically aligned and secured to receptacle 34, at which point a charging operation can be carried out. In examples, upon completion of the charging operation, plug 42 is magnetically and/or mechanically released from plug 34, charging cord 44 is vertically retracted, and controllable arm 46 is returned to a retracted position.

With reference to FIG. 2B, in lieu of employing a controllable arm, which may prevent an obstacle to users walking about EV 10, such as within a residential garage, for example, charging station 40 employs a movable carriage 48 mounted vertically above EV 10, such as on the ceiling of residential garage or other parking facility, for example. Charging station 40 controls movement of carriage 48 in the x- and y-direction, in a fashion similar to that described with regard to controllable arm 46, to align plug 42 of power cord 44 with receptacle 34.

With reference to FIGS. 3A-3C, in some examples, receptacle 34 may be implemented as an inductive charging panel have one or more inductive type receiving coils which is configured to engage a plug 42 of charging station 40 which is configured as an inductive charging mat having a number of inductive transmitting coils so as to provide wireless charging of battery 14.

With reference to FIG. 3A, according to one example, charging station 40 communicates (e.g., wireless) to EV 10 when it is in physical range for charging, at which point EV 10 initiates a charging mode of operation, where the vehicle ceases movement and charging tray 32 is moved from the stored position to a partially extended position. In examples, as illustrated by FIG. 3B, upon reaching the partially extended position, receptacle 34, which comprises a charging panel 34 having one or more inductive receiving coils, is rotated from a horizontal position to a vertical position. With reference to FIG. 3C, once charging panel 34 is vertically positioned, charging tray 32 is further extended to a charging position where charging panel 34 comes into contact with plug 42 of charging station 40 which, in this case is implemented as charging panel 42 having a number of inductive transmitting coils. Once receiving charging panel 34 of EV 10 is positioned in contact with transmitting charging panel 42 of charging station 40, a charging operation is commenced where inductive transmitting coils of transmitting charging panel 42 are energized to induce a charging current within the inductive receiving coils of charging panel 34. Upon completion of the battery charging operation, charging tray 32 is returned to the stored position.

In one example, as illustrated by FIG. 4, charging port 30, according to examples of the present disclosure, is implemented as an add-on device that may be retrofitted to EV 10. In examples, as illustrated, EV 10 includes a first (factory) charging port 18 which is electrically connected to battery charger 16. Charging port 30, according to the present disclosure, includes an electrical connection device 39 which is electrically connected between first charging port 18 and battery charger 16 so that charging port 30 is connected in parallel with first charging port 18, wherein charging port 30 serves as an alternate charging port that can be used in lieu of first charging port 18 when desired.

It is recognized that the charging system of the present disclosure can be configured for use in many charging system applications, including those not disclosed herein.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein.

The claims are part of the specification.

1. An electric vehicle charging system comprising:
a charging port disposed on an electric vehicle, the charging port including:
a receptacle configured to connect to a plug of an external electric vehicle charging station, the receptacle electrically connected to a battery charger of the electric vehicle; and
a charging tray on which the receptacle is disposed, wherein the charging tray is moveable between a stored position within a body of the electric vehicle and a charging position where the receptacle is exposed from the body of the vehicle to receive the plug of the external electric vehicle charging station.

2. The electric vehicle charging system of claim 1, wherein the receptacle is disposed in a horizontal position when the charging tray is in the charging position.

3. The electric vehicle charging system of claim 1, wherein the receptacle comprises a plug type connector.

4. The electric vehicle charging system of claim 3, wherein the plug type connector comprises a J1772 type connector.

5. The electric vehicle charging system of claim 1, wherein the receptacle comprises a surface type connector having surface contacts.

6. The electric vehicle charging system of claim 1, wherein the charging port is disposed such that the charging tray extends from a front of the electric vehicle.

7. The electric vehicle charging system of claim 1, wherein the charging port is disposed such that the charging tray extends from a rear of the electric vehicle.

8. The electric vehicle charging system of claim 1, wherein the charging port is disposed such that the charging tray extends from a side of the electric vehicle.

9. The electric vehicle charging system of claim 1, wherein the charging port is disposed on an underside of the electric vehicle.

10. The electric vehicle charging system of claim 1, wherein the charging port includes a cleaning mechanism that cleans debris from the charging tray and receptacle when the charging is moved between the stored and charging positions.

11. The electric vehicle charging system of claim 1, wherein the receptacle comprises a receiving charging panel including one or more inductive receiving coils, with the charging tray in the charging position, the receiving charging panel is disposed in proximity to an external transmitting charging panel of the external electric vehicle charging station having one or more inductive transmitting coils.

12. The electric vehicle charging system of claim 11, the receiving charging panel to be held in contact with the transmitting charging panel when the charging tray is in the charging position.

13. A charging port system for an electric vehicle comprising:
a receptacle configured to connect to a plug of a charging station, the receptacle electrically connected to a battery charger of the electric vehicle; and
a charging tray on which the receptacle is disposed, the charging tray selectively moveable between a stored position, where the receptacle is inaccessible to an exterior environment, and a charging position where the receptacle is exposed to the exterior environment to receive the plug of the charging station.

14. The charging port system of claim 13, wherein the charging tray extends beyond a perimeter of a body of the electric vehicle when in the charging position.

15. The charging port system of claim 13, wherein the receptacle is electrically connected in parallel with a second charging port of the electric vehicle.

16. The charging port system of claim 13, wherein the receptacle is a plug-type receptacle for a male-female type connection.

17. The charging port system of claim 13, wherein the receptacle comprises a surface type receptacle having a plurality of surface contacts for connecting to a surface type charging station plug.

18. The charging port system of claim 17, wherein the surface type receptacle includes magnetic contacts for securing to the charging station plug.

19. The charging port system of claim 13, wherein the receptacle comprises a receiving charging panel including one or more inductive receiving coils, with the charging tray in the charging position, the receiving charging panel is disposed in proximity to, or in contact with, an external transmitting charging panel of the external electric vehicle charging station having one or more inductive transmitting coils.

20. The charging port system of claim 13, wherein the charging port includes a cleaning mechanism that cleans debris from the charging tray and receptacle when the charging tray is moved between the stored and charging positions.
